(19) United States
(12) Patent Application Publication
(10) Pub. No.: US 2026/0100106 A1
(43) Pub. Date: Apr. 9, 2026

(54) ROULETTE STYLE GAMING SYSTEM

(71) Applicant: Amuse d.o.o., Ljubljana (SI)

(72) Inventors: Kenji ENOKIDO, Kanagawa (JP); Kazunori OTSUKA, Tokyo (JP); Shigeki SATO, Tokyo (JP); Gou MIYAMOTO, Saitama (JP); Junichi MURAKAMI, Kanagawa (JP)

(21) Appl. No.: 19/347,626

(22) Filed: Oct. 1, 2025

Related U.S. Application Data
(60) Provisional application No. 63/702,913, filed on Oct. 3, 2024.

(51) Int. Cl. G07F 17/32

(52) U.S. Cl. CPC G07F 17/3288; G07F 17/3211; G07F 17/323; G07F 17/3258; G07F 17/3262; G07F 17/3276

(57) ABSTRACT

A gaming system, includes: a plurality of player stations, where each comprises a graphical user interface allowing players to interact with the gaming system; a first motorized lottery wheel, including a first plurality of gaming ball pockets distributed in a concentric ring thereabout and a first LED display ring radially adjacent to the first plurality of gaming ball pockets, each of the first plurality of gaming ball pockets having a ball-sensor for sensing the presence of a gaming ball in the pocket; a second motorized lottery wheel, concentrically positioned within the first lottery wheel, including a second plurality of gaming ball pockets distributed in a concentric ring thereabout, each of the second plurality of gaming ball pockets having a ball-sensor for sensing the presence of a gaming ball in the pocket; a gaming ball launcher including a first shoot for launching one or more gaming balls to the first lottery wheel and a second shoot for launching one or more gaming balls to the second lottery wheel; a return mechanism for returning gaming balls from the respective gaming ball pockets to the gaming ball launcher; and a controller including one or more processors operatively communicating with and/or controlling the operation of the plurality of player stations, the first motorized lottery wheel, the first LED display ring, second motorized lottery wheel, the ball-sensors, the gaming ball launcher and the return mechanism to facilitate gameplay of the gaming system.

### CROSS REFERENCE TO RELATED APPLICATIONS

The present application claims the benefit of U.S. Provisional Ser. No. 63/702,913, filed Oct. 3, 2024, the entirety of which is incorporated by reference herein.

### BACKGROUND

Roulette is a popular game played in gaming establishments. In mechanical versions of the game (versus video generated), a roulette ball is launched into a stationary rim having a single angled annular track encircling a spinning roulette wheel. The spinning wheel rotates in the opposite direction of the rotating roulette ball. The roulette ball rotates around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number and color. The particular number represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number and color on the layout corresponding to the ball slot in which the roulette ball came to rest. Winning and losing selections for that game cycle that had been electronically or physically placed on the selection area prior to a selection close time of that game cycle are then determined according to the result. Once the losing and winning selections are resolved, a new game cycle starts.

### SUMMARY

In a first aspect, a gaming system includes: a plurality of player stations, where each comprises a graphical user interface allowing players to interact with the gaming system; a first motorized lottery wheel, including a first plurality of gaming ball pockets distributed in a concentric ring thereabout and a first LED display ring radially adjacent to the first plurality of gaming ball pockets, each of the first plurality of gaming ball pockets having a ball-sensor for sensing the presence of a gaming ball in the pocket; a second motorized lottery wheel, concentrically positioned within the first lottery wheel, including a second plurality of gaming ball pockets distributed in a concentric ring thereabout, each of the second plurality of gaming ball pockets having a ball-sensor for sensing the presence of a gaming ball in the pocket; a gaming ball launcher including a first shoot for launching one or more gaming balls to the first lottery wheel and a second shoot for launching one or more gaming balls to the second lottery wheel; a return mechanism for returning gaming balls from the respective gaming ball pockets to the gaming ball launcher; and a controller including one or more processors operatively communicating with and/or controlling the operation of the plurality of player stations, the first motorized lottery wheel, the first LED display ring, second motorized lottery wheel, the ball-sensors, the gaming ball launcher and the return mechanism to facilitate gameplay of the gaming system.

In a second aspect, a gaming system includes: a plurality of player stations, each comprising a graphical user interface allowing players to interact with the gaming system; a first motorized lottery wheel, including a first plurality of gaming ball pockets distributed in a concentric ring thereabout and a first LED display ring radially adjacent to the first plurality of gaming ball pockets, each of the first plurality of gaming ball pockets having a ball-sensor for sensing the presence of a gaming ball in the pocket; a gaming ball launcher including a first shoot for launching one or more gaming balls to the first lottery wheel; a return mechanism for returning gaming balls from the respective gaming ball pockets to the gaming ball launcher; and a controller including one or more processors operatively communicating with and/or controlling the operation of the plurality of player stations, the first motorized lottery wheel, the first LED display ring, the ball-sensors, the gaming ball launcher and the return mechanism to facilitate gameplay of the gaming system.

In a more detailed embodiment of the first or second aspects, the LED display ring is controlled by the one or more processors to display Roulette symbols adjacent to the first plurality of gaming ball pockets. In a further detailed embodiment, the gameplay is configured to shuffle the location of Roulette symbols between games.

Alternatively or in addition, the LED display ring is controlled by the one or more processors to display a combination of Roulette symbols, Bonus indicators, Jackpot indicators and/or Odds-Up indicators adjacent to the first plurality of gaming ball pockets.

In a detailed embodiment of the first aspect, the gameplay is configured to launch a gaming ball to the second motorized lottery wheel upon sensing a gaming ball in a predetermined gaming ball pocket in the first motorized lottery wheel. In a more detailed embodiment, the predetermined gaming ball pocket is adjacent to a portion of the LED display ring indicating that the predetermined gaming ball pocket is a special pocket and not a traditional Roulette pocket. In a more detailed embodiment, the gameplay is configured to provide two or more of the special pockets. Alternatively, or in addition, the gameplay is configured to launch one or more additional gaming balls to the first motorized lottery wheel upon sensing a gaming ball in a predetermined gaming ball pocket in the second motorized lottery wheel. Alternatively, or in addition, the gameplay is configured to increase the odds on one or more gaming ball pockets on the first motorized lottery wheel for subsequent gaming sessions upon sensing a gaming ball in a predetermined gaming ball pocket in the second motorized lottery wheel.

In a more detailed embodiment of the first or second aspects, the gameplay is configured to enter into a jackpot mode upon sensing a gaming ball in a predetermined gaming ball pocket in the first motorized lottery wheel or in the second motorized lottery wheel. In a further detailed embodiment, the graphical user interface allows a player to place a bet on the jackpot pocket and the predetermined gaming ball pocket is adjacent to a portion of the LED display ring indicating that the predetermined gaming ball pocket on the first motorized lottery wheel is a jackpot pocket in place of or in addition to a traditional Roulette pocket. In a further detailed embodiment, the gameplay is configured to select individual players for a chance to bet on the jackpot pocket based upon the individual player's amount of bets. In a further detailed embodiment, one or more other players are provided with an option to share in the individual player's bonus bet upon placing a corresponding bet on the one or more other players'graphical user interface. Alternatively or in addition, jackpot mode includes providing a plurality of jackpot win stages along the LED display ring and then launching one or more gaming balls to the first motorized lottery wheel and then awarding payout to one or more players depending upon which pocket or pockets the one or more gaming balls land.

In a more detailed embodiment of the first or second aspects, the gameplay is configured to provide one or more players the ability, via the players'graphical user interfaces, to bet on preselected pockets that have increased odds. In a further detailed embodiment, the provision of the ability for players to bet on preselected pockets that have increased odds is provided in an initial betting cycle and in a subsequent betting cycle after the initial betting cycle. Alternatively, or in addition, the amount that a player may bet on an increased odds pocket is capped by the gameplay. Alternatively, or in addition, the gameplay is configured to provide one or more players the ability to pay for the gameplay to provide more increased odds pockets via the players'graphical user interface; and, upon a player purchasing the paying for more increased odds pockets, providing additional ability for one or more players to bet on more preselected pockets that have increased odds.

In an embodiment, the displayed Roulette symbols are displayed sequentially around the circumference of the LED ring.

In an embodiment, the gameplay is configured to provide two or more lottery functions for the first motorized lottery wheel, wherein the gameplay is configured to change the display of the LED ring upon changing the lottery functions.

In an embodiment, each pocket in the first motorized lottery wheel includes a retractable stopper mechanism.

In an embodiment, the ability to bet on preselected pockets with increased odds occurs upon an amount of bets reaching a predetermined level.

In an embodiment, the gameplay provides for the launch of one or more gaming balls to the second motorized lottery wheel progressively within a gaming session.

These and other aspects will be apparent from the following description, the attached drawings and the appended claims.

### BRIEF DESCRIPTION OF THE DRAWINGS

FIG. 1 is perspective view of a gaming system in accordance with an embodiment.

FIG. 2 is a view of a centralized gaming area including an outer lottery wheel and a concentric inner lottery wheel in accordance with an embodiment.

FIG. 3 is a top view of the centralized gaming area in accordance with an embodiment.

FIG. 4 includes further views of the centralized gaming area in accordance with an embodiment.

FIG. 5 is an internal view of the centralize gaming area further providing a close-up illustrating a motorized gear or wheel for causing simultaneous and opposite rotations of both the outer lottery wheel and the inner lottery wheel in accordance with an embodiment.

FIG. 6 is a close-up illustration of a conductive slip ring that provides a wireless electrical connection between a central hub and a spinning wheel in accordance with an embodiment.

FIG. 7 is an illustration of a game rule in accordance with an embodiment.

FIG. 8 is an illustration of game flow when a multiplier is on in accordance with an embodiment.

FIG. 9 is an illustration of an odds up feature in accordance with an embodiment.

FIG. 10 is a further illustration of the odds up feature of FIG. 9 in accordance with an embodiment.

FIG. 11 is an illustration of additional options associated with the odds up feature in accordance with an embodiment.

FIG. 12 is an illustration of a jackpot feature in accordance with an embodiment.

FIG. 13 is a further illustration of the jackpot feature of FIG. 12 in accordance with an embodiment.

FIG. 14 is an illustration of a bonus stage feature in accordance with an embodiment.

FIG. 15 is an illustration of the game flow for the bonus stage feature in accordance with an embodiment.

FIG. 16 is an illustration of a dragon mode feature in accordance with an embodiment.

FIG. 17 is an illustration of different pocket numbering features in accordance with an embodiment.

FIG. 18 is an illustration of a computing system in accordance with an embodiment.

### DESCRIPTION OF THE DETAILED EMBODIMENTS

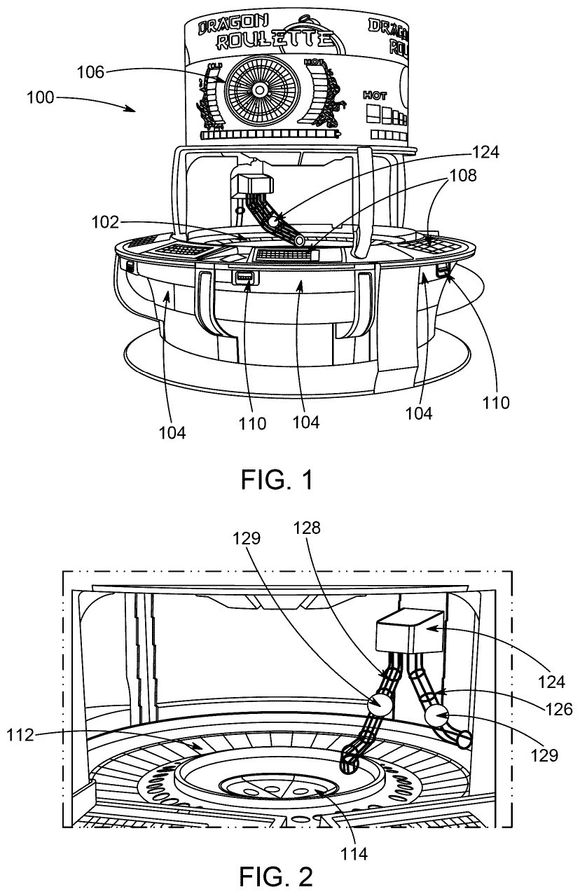

As shown in FIG. 1, a gaming system 100 according to the current disclosure may include a centralized gaming area 102, surrounded by a plurality of player stations 104. A (cylindrical in this embodiment) LED display screen 106 may be provided above the gaming area 102 to promote the game and/or display results and/or status of the gaming occurring in the gaming area 102. Each player station 104 may include a touch screen display 108 for allowing the respective players to provide player inputs (e.g., place bets and so forth as described herein) and to view input options and results (as described in detail herein). Each player station 104 may also include card slots 110 for receiving player loyalty cards, payment cards (e.g., credit, debit cards and the like) or other magnetic or chip-based information/payment cards as is known in the art.

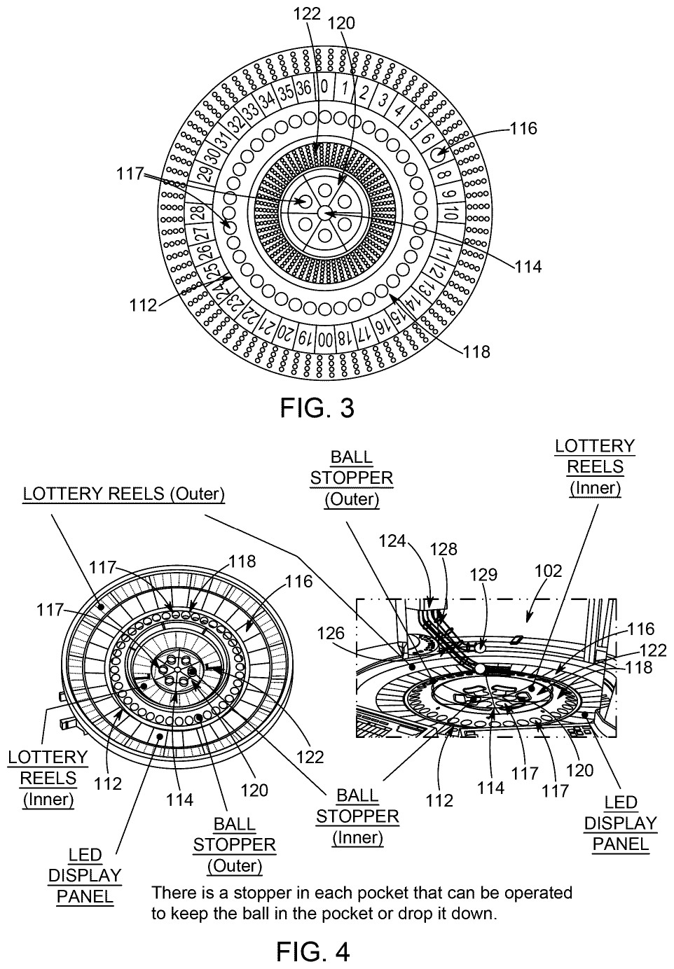

As shown primarily in FIG. 2, FIG. 3 and FIG. 4, the centralized gaming area 102 includes an outer lottery wheel 112 and a concentric inner lottery wheel 114. In the disclosed embodiments, the outer lottery wheel 112 provides variations of a traditional (and non-traditional) roulette gaming wheel, while the inner lottery wheel 114 provides a supplemental gaming stage such as a “bonus” stage as described herein. The outer lottery wheel 112 includes an outer ring 116 of number/symbol displays, which may be an LED number display in an exemplary embodiment, and a concentric inner ring 118 of ball pockets 117. The inner lottery wheel 114 includes an inner ring 120 of color-coded ball pockets 117 as discussed further herein and may include an outer LED display ring 122. A ball launcher 124 (controlled by processor(s)) is provided that includes a pair of ball-launch shoots-a first ball-launch shoot 126 for launching gaming ball(s) 129 to the outer lottery wheel 112 and a second ball-launch shoot 128 for launching gaming ball(s) 129 to the inner lottery wheel 114. Depending on the game play (non-limiting examples of which are described in detail herein), the gaming balls 129 may be launched separately or simultaneously by the ball-launch shoots 126/128 and multiple gaming balls 129 may be launched from a single ball-launch shoot 126/128.

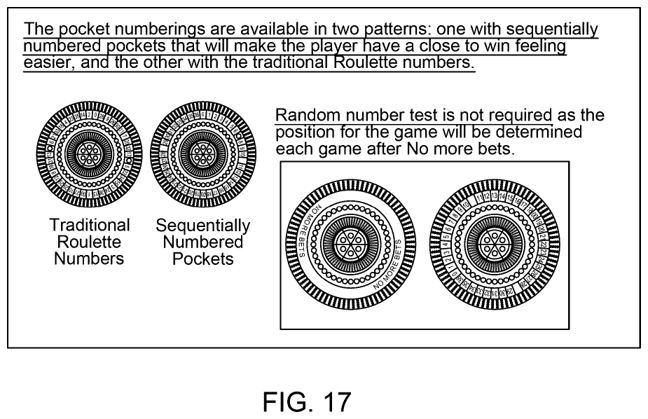

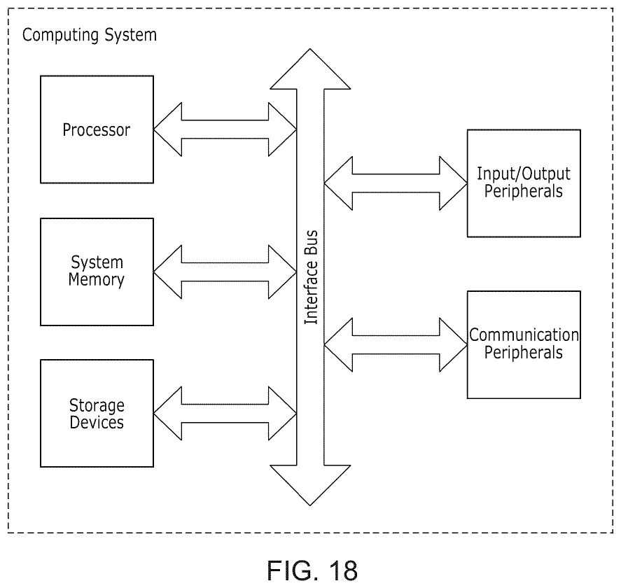

As described in further detail herein, the outer ring 116 of LED displays may provide various arrangement of roulette numbers and/or related gaming symbols (as controlled by processor(s)) associated with the game play, where each LED display may correspond to one or more ball pocket 117 in the inner ring 118 and vice-versa. For example, referring to FIG. 17, in an embodiment the outer ring 116 of LED displays may provide an arrangement of traditional Roulette numbers corresponding to each adjacent gaming ball pocket 117. Alternatively in another embodiment, the outer ring 116 of LED displays may provide an arrangement of sequentially numbered displays (circumferentially around the outer ring 116) corresponding to each adjacent gaming ball pocket 117. Such a design may eliminate or reduce the use of a random number test as the position of the Roulette numbers may be determined by (by the processor(s)), for example, after the player bets have been received (i.e., the “No More Bets” stage as discussed herein for certain embodiments). For example, the processor(s) can be programmed to shuffle the positions of each Roulette number (and other symbols) around the outer lottery wheel 112 for each game. The Roulette number order may also be randomized for each game.

As shown in FIG. 17 and described and illustrated herein, the processor controlled outer ring 116 of LED displays also allows for additional, animated and/or exciting displays of gaming status, features and so forth. For example, as shown in FIG. 17, the outer ring of LEDs can be used to show game status or player instructions such as “New Bets Please” or “No More Bets.” As also shown in FIG. 17 (and herein) the outer ring 116 of LEDs may also be used to show or animate various “Bonus” or “Jackpot” symbols or indications adjacent to gaming ball pocket(s) 117, “Odds-up” or multiplier indications associated with gaming ball pocket(s), indications that player(s) placed a bet on a gaming ball pocket(s) 117 and its associated LED-displayed number or symbol, indication that the gaming ball 129 has landed in a particular ball pocket 117, indications that certain gaming ball pockets 117 are grouped together with respect to certain gaming functions, and so forth. It is also within the scope of the current disclosure that similar LED display functions (again as controlled by the processor(s)) may be utilized for the outer LED display ring 122 associated with the inner lottery wheel 114 and its gaming ball pockets 117.

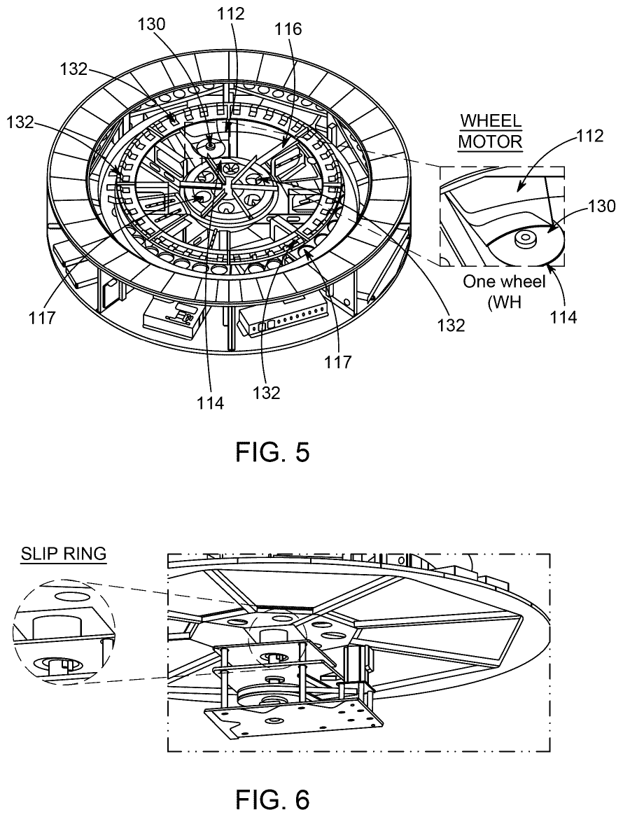

As shown specifically in FIG. 5, an embodiment includes a motorized gear or wheel 130 provided radially between and engaging the outer lottery wheel 112 and the inner lottery wheel 114 so that motorized rotation of the gear/wheel 130 (as initiated and controlled by the processor(s)) causes simultaneous and opposite rotations of both the outer lottery wheel 112 and the inner lottery wheel 114. In an embodiment, the gear/wheel 130 may be vertically and/or radially moved (as controlled by the processor(s)) to selectively engage and/or disengage with the outer and inner lottery wheels 112/114 so that the gear/wheel can be used to separately drive each lottery wheel 112/114 depending upon the stage of game play. It is also within the scope of the disclosure to have separate drives for each lottery wheel 112/114. As further shown in FIG. 5, each ball pocket 117 in the outer ring and inner ring 118 also includes a corresponding sensor 132 (as an input to the processor(s)) for sensing the presence of a gaming ball 129 landing into the pocket. The sensors may be optical, weight-base, magnetic, etc., depending on the material used to manufacture the gaming balls 129, the structure of each ball pocket 117, and other factors.

As shown in FIG. 4, there is a ball stopper in each pocket that can be operated to keep the ball in the pocket or drop it down to a return path. That is, tach pocket 117 includes a retractable stopper, like a trapdoor. When engaged, the stopper keeps the gaming ball 129 in the pocket 117, and when disengaged the ball is permitted to fall through the pocket to the associated ball-return mechanism (not shown), which may return the ball back to the ball launcher 124.

As shown specifically in FIG. 6, an embodiment includes a conductive slip ring that provides a wireless electrical connection between a central hub and a spinning wheel, such as the outer lottery wheel 112. This slip ring thus allows the processor(s) to communicate with the LED displays of the outer ring 116 and with the various sensors 132 while the respective lottery wheel is spinning.

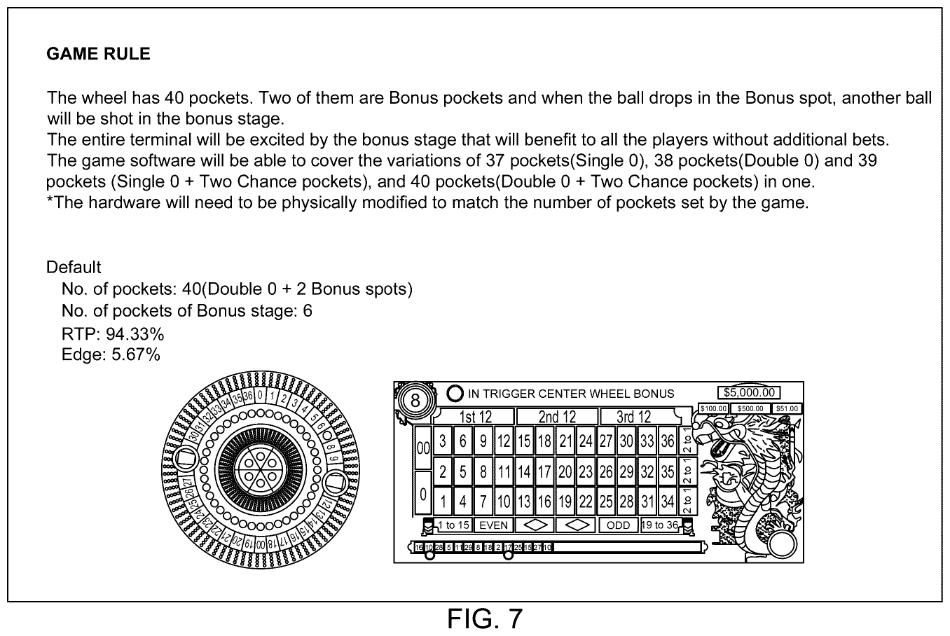

FIGS. 7-16 provide non-limiting examples of game play using the above-disclosed gaming system.

Referring to FIG. 7, in an embodiment, the outer lottery wheel 112 may include forty ball pockets 117 and the inner lottery wheel 114 may include six ball pockets 117. In the outer lottery wheel, 38 of the pockets correspond to numbers 0, 00 and 1-36, and two of the pockets 117 may be “Bonus” pockets while the other thirty-eight may be more traditional Roulette wheel pockets. The game software of the gaming system may include variations of 37 pockets (Single 0), 38 pockets (Double 0) and 39 pockets (Single 0+Two bonus/chance pockets), and 40 pockets (Double 0+Two bonus/chance pockets) in one. The hardware of the gaming system may need to be physically modified to match the number of pockets set by the game. The outer ring 116 of LED displays may be operated by the processor to indicate which Roulette numbers and/or Bonus symbols will be associated with the corresponding ball pockets 117. During gameplay, a ball 129 will first be launched from the first ball-launch shoot 126 to the outer lottery wheel 112. When the ball 129 drops in a traditional Roulette wheel pocket, players who made the appropriate bets are paid out according to traditional Roulette odds (subject to “Odds up” options described herein); and when the ball 129 drops into a “Bonus” pocket another ball 129 will be launched from the second ball-launch shoot 128 to the inner lottery wheel 114 as part of Bonus Stage gameplay. All players of the gaming system will be excited by the bonus stage because it will benefit all of the players without requiring additional bets.

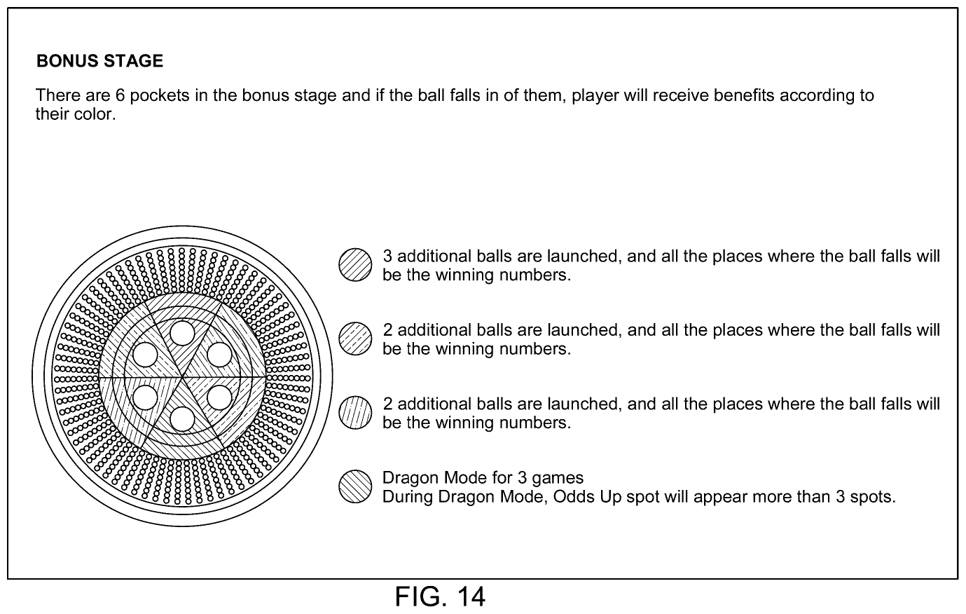

Referring to FIG. 14, exemplary Bonus Stage gameplay is illustrated. The inner lottery wheel 114 may have six color-coded ball pockets 117, where each color pertains to additional gaming benefits if the gaming ball 129 lands in that slot on the inner lottery wheel 114. For example, a Red coded slot may provide that three additional gaming balls 129 will be launched to the outer lottery wheel 112 (during a Bonus spin) and where the gaming balls land will be winning numbers (paying off corresponding bets on those numbers); a Blue coded slot or a Green coded slot may provide that two additional gaming balls 129 may be launched to the outer lottery wheel 112 (during a Bonus spin); and a Violet coded slot may indicate that the gaming system 100 enters “Dragon Mode” for three games in which additional Odds Up spots will appear during game play.

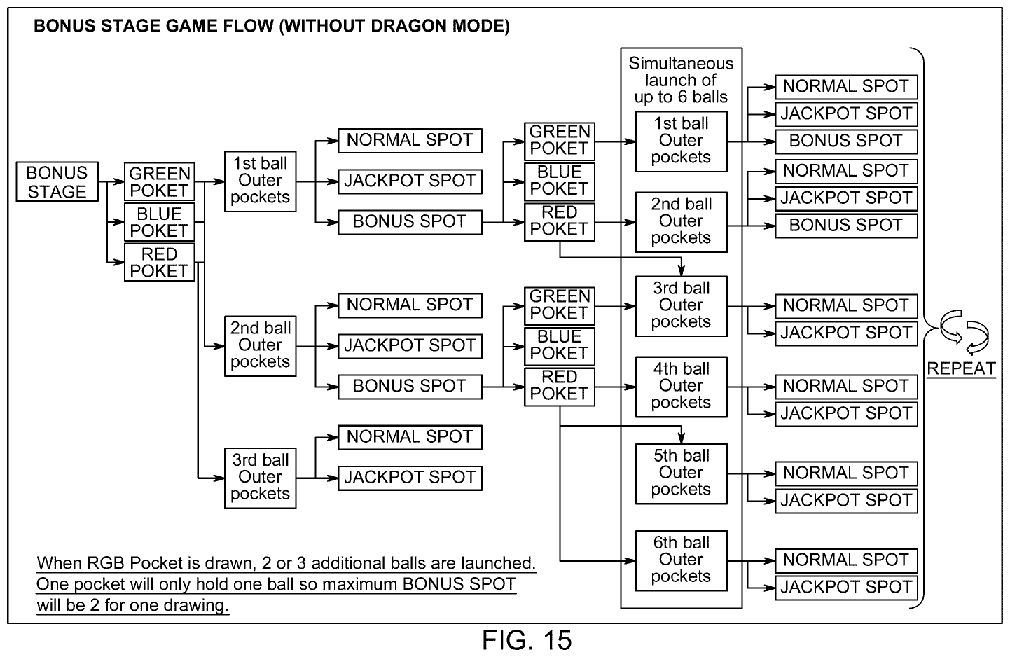

FIG. 15 provides an example, self-explanatory progressive Bonus Stage flow diagram. As can be seen in FIG. 15, it is possible that, during the Bonus spin on the outer lottery wheel 112 in which two or three additional gaming balls 129 are launched, such additional gaming balls 129 may fall again into one or both of the gaming ball pockets 117 marked as “Bonus” pockets. This would again cause the Bonus Stage to be repeated with the inner lottery wheel 114, and the resulting launching of even more bonus stage gaming balls to the outer lottery wheel 112. This could be repeated indefinitely (or until a pre-determined limit) until no additional gaming balls fall into the “Bonus”marked pockets.

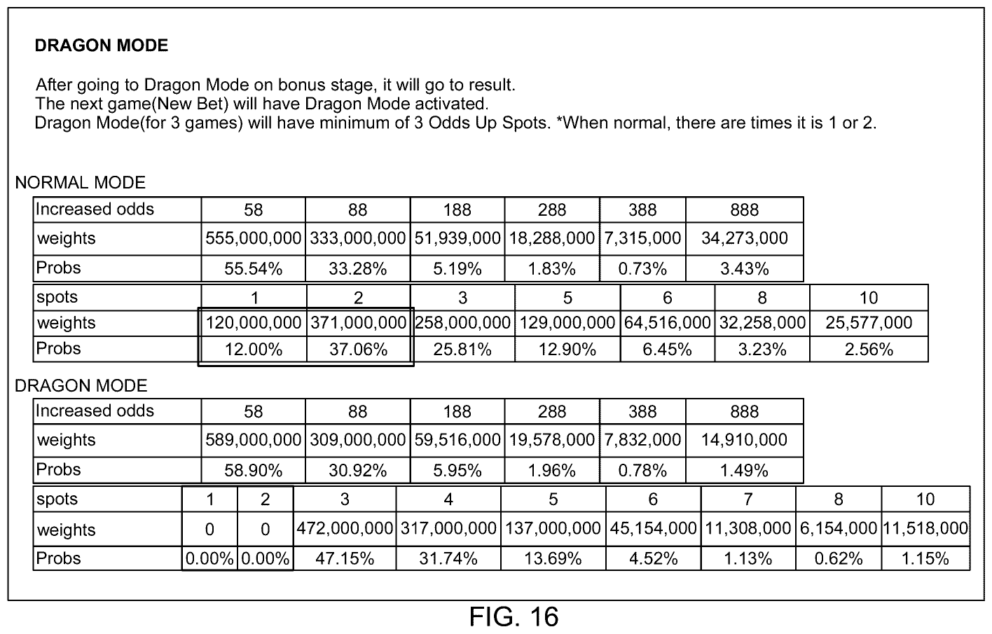

As shown in FIG. 16, an example Dragon Mode provides that subsequent Dragon Mode games will have a minimum of three Odds Up spots as compared to normal gaming in which there one or two Odds Up spots.

Referring back to FIG. 7, alternate embodiments of the outer lottery wheel 112 may include variations of the number and arrangement of ball pockets 117. For example, thirty seven pockets (Single 0 pocket), thirty-eight pockets (Single 0 and Double 00), thirty-nine pockets (Single 0 and two Bonus pockets), forty pockets (Single 0, Double 00 and two Bonus pockets), etc. As discussed and illustrated herein, the processor(s) may be programmed to display multiple variations of numbers, symbols, animations, messages and so forth in the LED displays in the respective LED ring displays 116 and/or 122 to provide and/or promote gameplay.

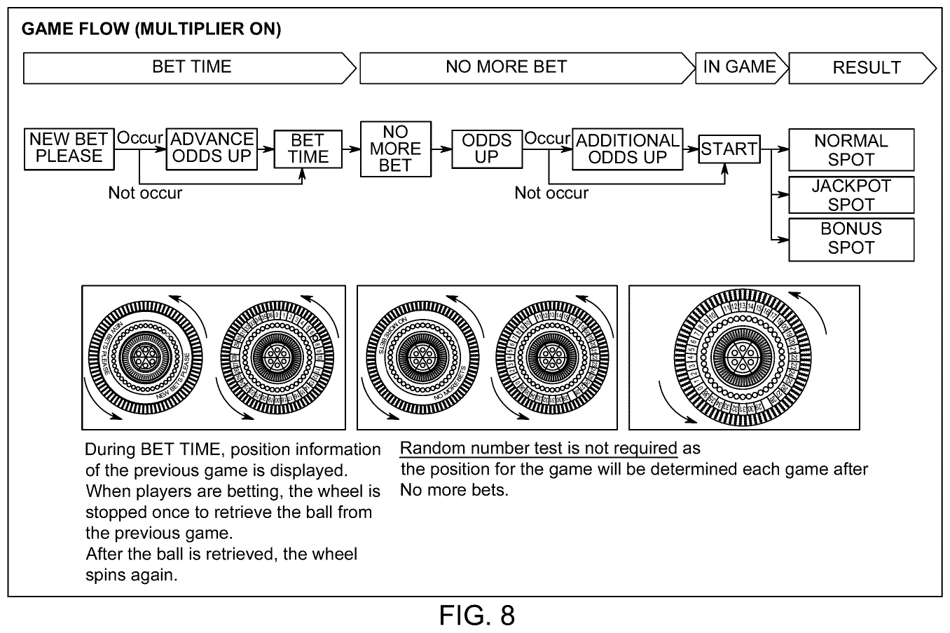

FIG. 8, illustrates an exemplary flow of gameplay involving four primary stages: Bet Time, No More Bet, In Game and Result. The Bet Time stage allows players to place initial bets (associated with traditional Roulette style bets or otherwise depending upon the game). At this stage, the LED ring display 116 may include the “New Bets Please” message. If “Advance Odds Up” is enabled based on prior bonus stages, then players may make Advanced Odds Up bets or selections at the Bet Time stage as well. During the Bet Time stage, position information of the previous game is displayed in the LED ring display 116. When players are betting (using their player station touch screen display 108), the wheel 112 is stopped once to retrieve the ball 129 from the previous game. After the ball 129 is retrieved to the ball launcher 124, the wheel 112 spins again for the next game. It is important to note that no random number test of the gaming system by gaming regulators is required because the position of the numbers corresponding to each of the pockets is randomly determined for each after the no more bets. Accordingly, there is no way for a player to track that a ball has a tendency to land in a particular pocket because the number corresponding to the pocket changes with each game.

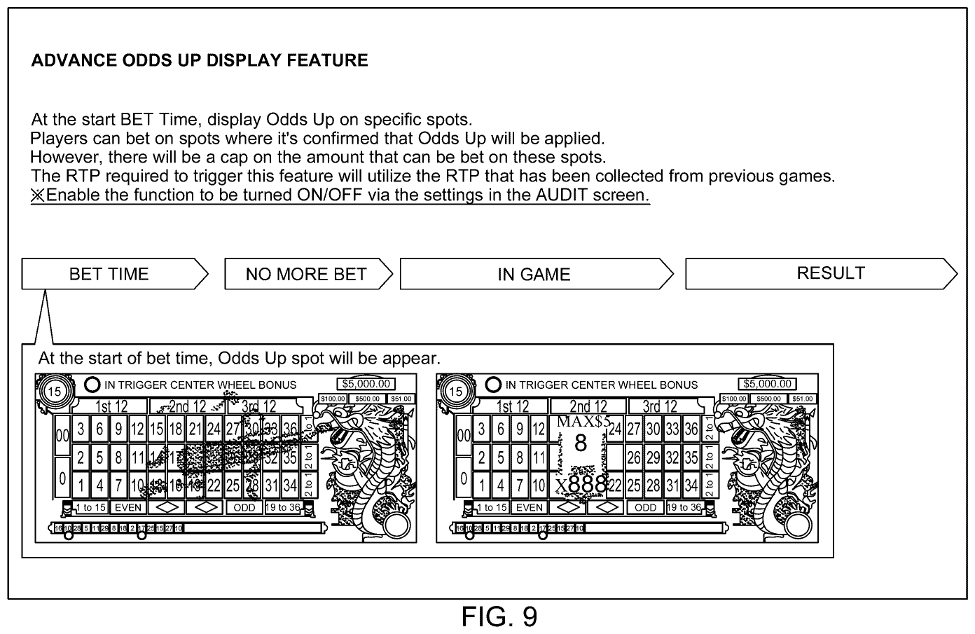

Referring to FIG. 9, at the Bet Time stage, the processor(s) may display on the players'touchscreen display 108 an “Odds Up” option on specific betting spots or numbers. At that stage, the players can bet on spots where it is confirmed that Odds Up will be applied. The game may provide a cap on the amount that any player can bet on these Odds Up spots. The Return-To-Player (RTP) required to trigger this feature may depend upon and utilize the RTP that has been collected from previous games or rounds.

Referring back to FIG. 8, the No More Bet Stage follows the Bet Time stage. At this stage, the LED ring display 116 may display “No More Bets” message, followed by the reshuffled display of Roulette style numbers and symbols associated with the ball pockets 117 for the next game (as controlled by the processor(s)). This feature may eliminate or reduce the need for a random number test.

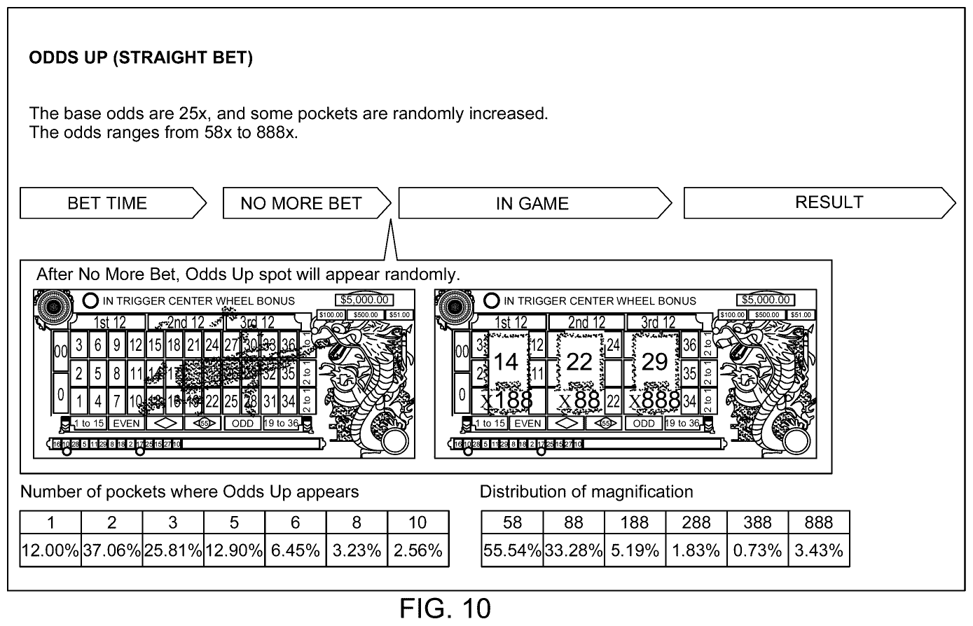

Referring to FIG. 10, after the No More Bet stage, additional “Odds Up” spots may appear randomly on betting spots on players'touchscreen display 108. The base odds may be 25×, with some pockets having randomly increase odds, which ranges from 58× to 888×.

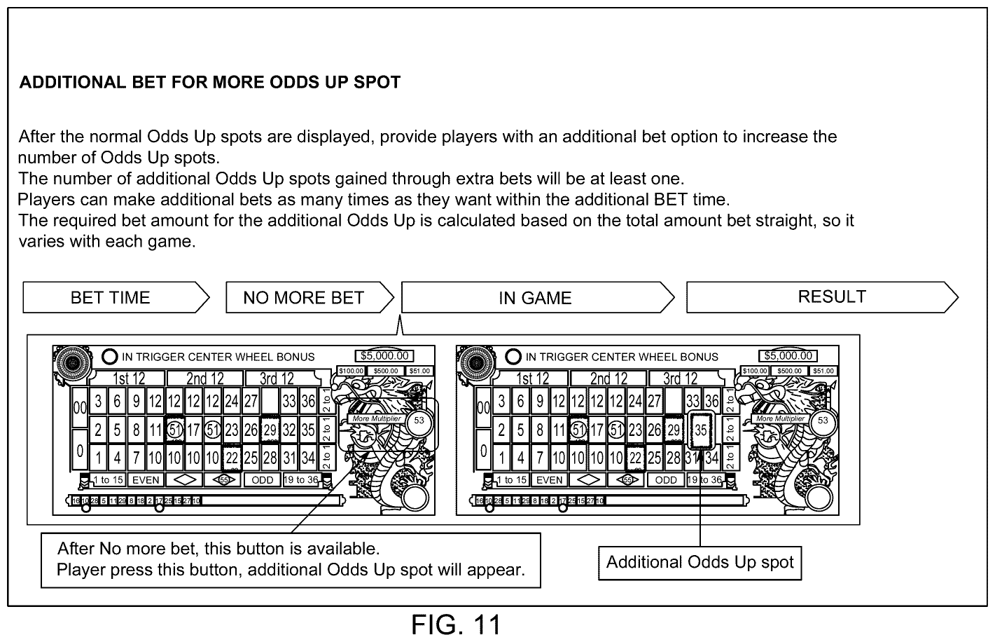

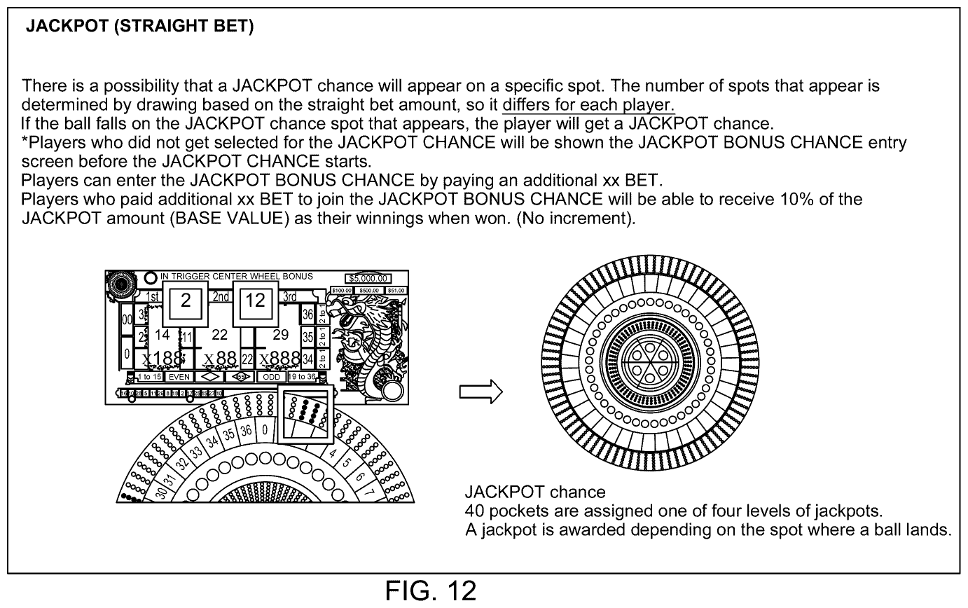

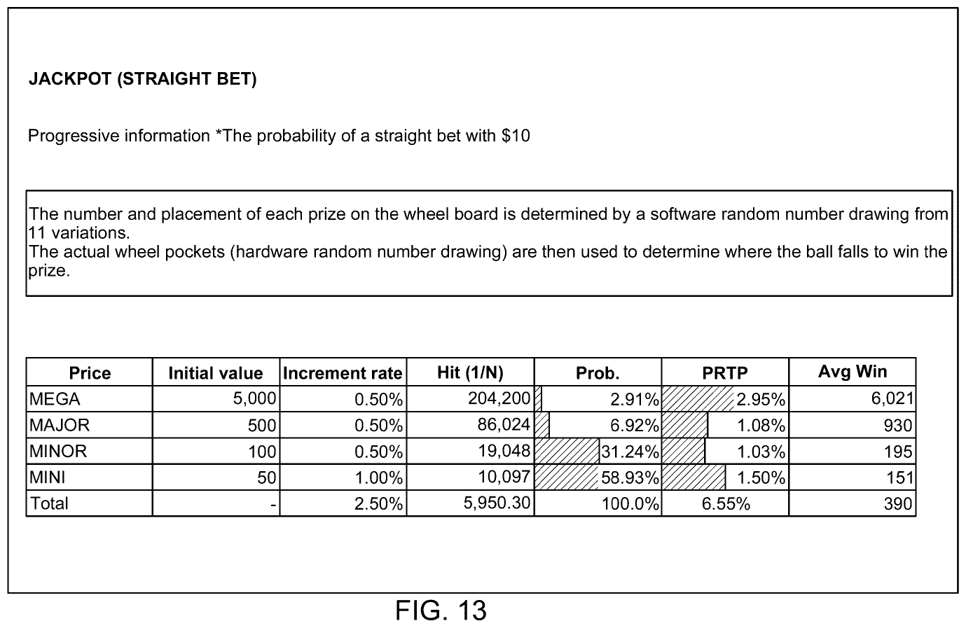

Then, as shown in FIG. 11, players can then use their touchscreen display 108 to place additional bets on new Odds Up spots. For example, during the No More Bet stage, the touchscreen display 108 may provide an icon if the player would like to receive more Odds Up spots for additional betting. Then, if the icon is activated by the player, then the touchscreen display 108 will highlight one or more additional spots with Odds Up odds. At that time, players can make additional bets within an allotted additional betting time. The required bet amount in this additional betting stage may be calculated based on total amount of straight bets in the Bet Time stage, for example.

Referring back to FIG. 8, the In Game stage follows the No More Bet stage. In the In Game stage, the processor(s) will spin the wheel(s) and launch the gaming ball(s) according to the determined game play. The Result stage follows the In Game stage. In the Result stage the processor(s) will determine gaming results depending upon where the gaming ball(s) land in ball pockets in the respective lottery wheels. Results may vary depending upon if the gaming ball(s) land in a normal spot vs. a Jackpot spot vs. a Bonus spot.

Referring to FIG. 12, the processor(s) may randomly place a Jackpot chance on a specific spot on the outer ring LED display 116 (so as to apply to all players) and/or may place a personal Jackpot chance on a specific spot on a player's touchscreen display 108 (so as to apply only to that player).

If the Jackpot chance is placed on one or more spots on a specific player's touchscreen display 108, it may be based on that player's straight bet amount (for that particular game and/or for a combination of prior games). Hence, the Jackpot chance may be different for each player. Then during the In Game stage, if a gaming ball 129 lands in such a Jackpot slot that player will get a Jackpot chance. As shown in FIG. 12, for the exemplary Jackpot chance, the outer ring LED display 116 (under control of the processor(s)) will assign one of four levels of jackpots to every associated ball pocket 117. The processor(s) will then spin the outer lottery wheel 112 and launch one or more gaming balls 129. The awarded Jackpot will depend upon which ball pocket(s) 117 the gaming ball(s) 129 lands at this stage. FIG. 13 provides an example progressive information chart for an exemplary Jackpot stage with four levels (Mega, Major, Minor and Mini) of Jackpot slots.

Referring back to FIG. 12, If the Jackpot chance is placed on one or more spots on a specific player's touchscreen display 108, then players who did not get selected for this personal Jackpot Chance may be shown on their touchscreen displays 108 a Jackpot Bonus Chance, which allows those players to join (at least in part) in the Jackpot round by placing an additional predetermined bet. Those players who join the Jackpot round by placing the additional bet will then be able to receive a percentage (e.g., 10%) of the Jackpot amount as their winnings.

As described herein, the gaming system includes one or more computing devices (see, e.g., the computing system of FIG. 18) including at least one processor and at least one memory communicatively coupled to the at least one processor. The computing device may be communicatively coupled to a gaming network, which may manage player accounts, gaming funds, bets, and other aspects of gameplay. In some examples, one or more player stations and/or mobile gaming devices may be located remotely from the gaming system 100 and enable gameplay through remote communication.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Some of the techniques described above can be implemented on a computing device associated with a gaming system 100 (e.g., a roulette mechanism), a plurality of computing devices associated with a plurality of gaming systems 100, a controller in communication with the gaming system(s) (e.g., a controller configured to synchronize the gaming system(s)), or a plurality of controllers in communication with the gaming system(s). Additionally, some of the techniques may be distributed between the computing device(s) and the controller(s). FIG. 18 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals may include user interfaces such as the touchscreen displays 108, display devices such as the LED display 106, 116, 122, speakers, and other input/output devices, and computing components such as digital-to-analog and analog-to-digital converters, graphical processing units, serial ports, parallel ports, and universal serial bus. The input/output peripherals may also include a variety of sensors, such as ball sensors 132, light, proximity, GPS, magnetic field, altitude, and velocity/acceleration. RSSI, and distance sensors, as well as other types of sensors. The input/output peripherals may also include the wheel motor(s) 130, the ball launcher 124, the card readers 110 and any other mechanism associated with gameplay. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like.

The processes and algorithms may be implemented partially or wholly in application-specific circuitry. The results of the disclosed processes and process steps may be stored, persistently or otherwise, in any type of non-transitory computer storage.

The various features and processes described above may be used independently of one another or may be combined in various ways. All possible combinations and sub-combinations are intended to fall within the scope of this disclosure. In addition, certain method or process steps may be omitted in some implementations. The methods and processes described herein are also not limited to any particular sequence, and the steps or states relating thereto can be performed in other sequences that are appropriate. For example, described steps or states may be performed in an order other than that specifically disclosed, or multiple steps or states may be combined in a single step or state. The example steps or states may be performed in serial, in parallel, or in some other manner. Steps or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

1. A gaming system, comprising:
a plurality of player stations, each comprising a graphical user interface allowing players to interact with the gaming system;
a first motorized lottery wheel, including a first plurality of gaming ball pockets distributed in a concentric ring thereabout and a LED display ring radially adjacent to the first plurality of gaming ball pockets, each of the first plurality of gaming ball pockets having a ball-sensor for sensing the presence of a gaming ball in the pocket;
a second motorized lottery wheel, concentrically positioned within the first lottery wheel, including a second plurality of gaming ball pockets distributed in a concentric ring thereabout, each of the second plurality of gaming ball pockets having a ball-sensor for sensing the presence of a gaming ball in the pocket;
a gaming ball launcher including a first shoot for launching one or more gaming balls to the first lottery wheel and a second shoot for launching one or more gaming balls to the second lottery wheel;
a return mechanism for returning gaming balls from the respective gaming ball pockets to the gaming ball launcher; and
a controller including one or more processors operatively communicating with and/or controlling the operation of the plurality of player stations, the first motorized lottery wheel, the LED display ring, second motorized lottery wheel, the ball-sensors, the gaming ball launcher and the return mechanism to facilitate gameplay of the gaming system.

2. The gaming system of claim 1 wherein the LED display ring is controlled by the one or more processors to display roulette symbols adjacent to the first plurality of gaming ball pockets.

3. The gaming system of claim 2, wherein the displayed roulette symbols are displayed sequentially around the circumference of the LED ring.

4. The gaming system of claim 2, wherein the gameplay is configured to shuffle the location of roulette symbols between games.

5. The gaming system of claim 1, wherein the LED display ring is controlled by the one or more processors to display a combination of roulette symbols, bonus indicators, jackpot indicators and/or odds-up indicators adjacent to the first plurality of gaming ball pockets.

6. The gaming system of claim 1, wherein the gameplay includes launching a second gaming ball to the second motorized lottery wheel upon sensing a first gaming ball in a predetermined gaming ball pocket in the first motorized lottery wheel.

7. The gaming system of claim 6, wherein the predetermined gaming ball pocket is adjacent to a portion of the LED display ring indicating that the predetermined gaming ball pocket is a special pocket and not a traditional roulette pocket.

8. The gaming system of claim 7, wherein the gameplay includes providing two or more of the special pockets.

9. The gaming system of claim 6, wherein the gameplay includes launching one or more additional gaming balls to the first motorized lottery wheel upon sensing the second gaming ball in a predetermined gaming ball pocket in the second motorized lottery wheel.

10. The gaming system of claim 1, wherein the gameplay includes launching the one or more gaming balls progressively within a gaming session.

11. The gaming system of claim 6, wherein the gameplay includes increasing the odds on one or more gaming ball pockets on the first motorized lottery wheel for subsequent gaming sessions upon sensing the second gaming ball in a predetermined gaming ball pocket in the second motorized lottery wheel.

12. The gaming system of claim 1, wherein the gameplay includes entering into a jackpot mode upon sensing a gaming ball in a predetermined gaming ball pocket in the first motorized lottery wheel or in the second motorized lottery wheel.

13. The gaming system of claim 12, wherein a graphical user interface allows a player to place a bet on a jackpot pocket, and wherein the predetermined gaming ball pocket is adjacent to a portion of the LED display ring indicating that the predetermined gaming ball pocket on the first motorized lottery wheel is the jackpot pocket and not a traditional roulette pocket.

14. The gaming system of claim 12, wherein the gameplay includes selecting individual players for a chance to bet on the jackpot pocket based upon amounts bet by the individual players.

15. The gaming system of claim 14, wherein one or more other players are provided with an option to share a bonus bet of an individual player upon placing a corresponding bet on the graphical user interface of the one or more other players.

16. The gaming system of claim 12, wherein the jackpot mode includes providing a plurality of jackpot win stages along the LED display ring and then launching one or more gaming balls to the first motorized lottery wheel and then awarding payout to one or more players depending upon which pocket or pockets the one or more gaming balls land within.

17. The gaming system of claim 1, wherein the gameplay includes providing one or more players the ability, via the graphical user interface, to bet on preselected pockets that have increased odds.

18. The gaming system of claim 17, wherein the provision of the ability for players to bet on preselected pockets that have increased odds is provided in an initial betting cycle and in a subsequent betting cycle after the initial betting cycle.

19. The gaming system of claims 17, wherein the amount that a player may bet on an increased odds pocket is capped by the gameplay.

20. The gaming system of claims 17, wherein the gameplay includes providing one or more players the ability to pay for the gameplay to provide more increased odds pockets via the graphical user interface; and, upon a player purchasing the paying for more increased odds pockets, providing additional ability for one or more players to bet on more preselected pockets that have increased odds.

21. The gaming system of claim 17, wherein the ability to bet on preselected pockets with increased odds occurs upon an amount of bets reaching a predetermined level.

22. The gaming system of claim 1, wherein the gameplay includes providing two or more lottery functions for the first motorized lottery wheel, and wherein the gameplay includes changing the display of the LED ring upon changing the lottery functions.

23. The gaming system of claim 1, wherein each pocket in the first motorized lottery wheel includes a stopper mechanism.

24. The gaming system of claim 23, wherein the stopper mechanism is a trapdoor.

25. A method for operating a gaming system of claim 1, comprising the steps of any of claim 2, 3, 4, 5, 6, 7, 8, 9, 10, 11, 12, 13, 14, 15, 16, 17, 18, 19, 20, 21, 22, 23 and 24.

26. A non-transitory memory device, comprising computer instructions configured to control one or more processors to perform any of the methods of claim 25.
